(19) United States
(12) Patent Application Publication
(10) Pub. No.: US 2025/0180977 A1
(43) Pub. Date: Jun. 5, 2025

(54) COOLING STRUCTURE FOR LIGHT SOURCE DEVICE AND PROJECTOR

(71) Applicant: Sharp NEC Display Solutions, Ltd., Tokyo (JP)

(72) Inventor: Yusuke TANI, Tokyo (JP)

(21) Appl. No.: 19/050,343

(22) Filed: Feb. 11, 2025

Related U.S. Application Data
(63) Continuation of application No. PCT/JP2022/034246, filed on Sep. 13, 2022.

(51) Int. Cl. G03B 21/16; F21V 29/67; F21V 29/76; F21V 29/83; G03B 21/20

(52) U.S. Cl. CPC G03B 21/16; F21V 29/673; F21V 29/763; F21V 29/767; F21V 29/83; G03B 21/2086

(57) ABSTRACT

A cooling structure for a light source device includes a light source, a heat dissipation plate having a mounting surface on which the light source is mounted, a plurality of heat dissipation fins arranged at intervals at intervals in a first direction along a back surface of the heat dissipation plate, and a blower fan that blows air toward the back surface via the plurality of heat dissipation fins. The plurality of heat dissipation fins are provided with a cover that is provided at each first end of the plurality of heat dissipation fines in a second direction along the back surface and covers a region corresponding to each distal end of the plurality of heat dissipation fins extending from the back surface toward the blower fan in a gap between the heat dissipation fins adjacent in the first direction. The plurality of first ends do not protrude outside the first edge of the heat dissipation plate in the second direction. An opening is formed at a position of the plurality of first ends corresponding to each basal end of the plurality of heat dissipation fins such that the gap between adjacent heat dissipation fins faces the outside of the plurality of heat dissipation fins.

### TECHNICAL FIELD

The present disclosure relates to a cooling structure for a light source device and a projector.

### BACKGROUND ART

Patent Document 1 discloses a light source device in which heat dissipation fins protrude from above and below a holding member (heat dissipation plate) on which a light source is mounted.

### CITATION LIST

### Patent Document

[Patent Document 1]

Japanese Unexamined Patent Application, First Publication No. 2020-144392

### SUMMARY OF INVENTION

### Technical Problem

However, due to the miniaturization of various devices including light source devices (for example, projectors), it may not be possible to make heat dissipation fins protrude both from above and below a holding member due to constraints on a space in which a light source device is disposed. In this case, a light source may not be sufficiently cooled, and thus it is required to improve the cooling efficiency of the light source.

The present invention has been made in view of these circumstances, and an object of the present invention is to provide a cooling structure for a light source device and a projector that can improve the cooling efficiency of a light source even if there is a space restriction.

### Solution to Problem

According to a first aspect of the present invention, there is provided a cooling structure for a light source device including a light source; a heat dissipation plate formed in a plate shape and having a mounting surface on which the light source is mounted; a plurality of heat dissipation fins formed in a plate shape in which a first direction along a back surface of the heat dissipation plate opposite to the mounting surface is a thickness direction and arranged at intervals in the first direction; and a blower fan disposed to face the back surface via the plurality of heat dissipation fins and blowing air toward the back surface. Each of first ends of the plurality of heat dissipation fins in a second direction orthogonal to the first direction along the back surface does not protrude outside of a first edge of the heat dissipation plate in the second direction. The plurality of heat dissipation fins are provided with a cover that is provided at the plurality of first ends and covers a region corresponding to each distal end in an extension direction of the plurality of heat dissipation fins extending from the back surface toward the blower fan in a gap between the heat dissipation fins adjacent in the first direction. A region corresponding to each basal end in the extension direction of the plurality of heat dissipation fins in the gap between the adjacent heat dissipation fins is covered with the cover, and thus an opening is formed at a position corresponding to each of the plurality of basal ends of the plurality of first ends such that the gap between adjacent heat dissipation fins faces the outside of the plurality of heat dissipation fins.

According to a second aspect of the present invention, there is provided a projector including the cooling structure for a light source device.

### Advantageous Effects of Invention

According to the present invention, even if there is a restriction on a space in which a light source device is installed, it is possible to improve the cooling efficiency of a light source.

### BRIEF DESCRIPTION OF DRAWINGS

FIG. 1 is a perspective view showing the appearance of a projector according to an embodiment of the present invention.

FIG. 2 is a perspective view showing a state in which an upper cover of a casing is detached in the projector in FIG. 1.

FIG. 3 is a perspective view in which only a light source device, a blower fan, and a duct configuring a cooling structure for the light source device remain on a bottom plate of the casing in FIG. 2.

FIG. 4 is a perspective view showing a state in which the blower fan and the duct are separated from the light source device in FIG. 3.

FIG. 5 is a perspective view showing the light source device and the blower fan in FIGS. 1 to 3.

FIG. 6 is a perspective view showing a state in which a case of an optical system is removed in FIG. 5.

FIG. 7 is a sectional view showing the cooling structure for the light source device in FIGS. 2 to 6.

FIG. 8 is a sectional view showing a modification example of the cooling structure for the light source device.

### DESCRIPTION OF EMBODIMENTS

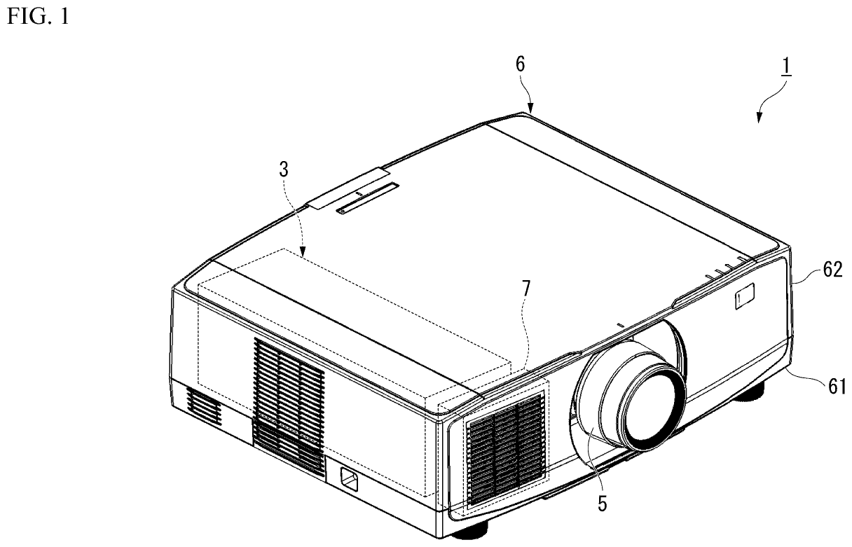

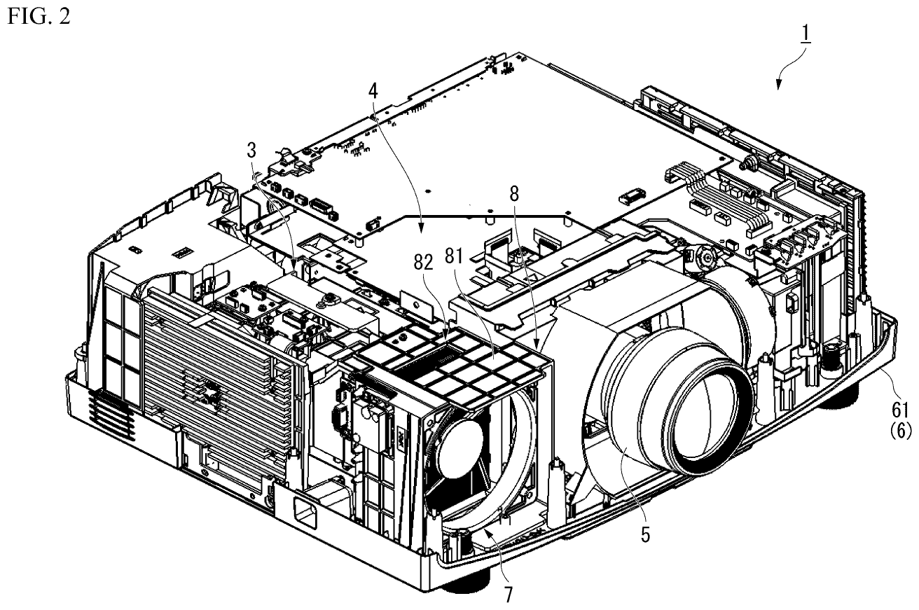

Hereinafter, an embodiment of the present invention will be described with reference to FIGS. 1 to 7.

As shown in FIGS. 1 to 3, a projector 1 according to the present embodiment is a device that projects image light (video) onto a display surface such as a screen. The projector 1 includes a light source device 3, an image light forming device 4, a projection device 5, a casing 6, a blower fan 7, and a duct 8.

The image light forming device 4 creates image light on the basis of light output from the light source device 3 that will be described later. Although not shown, the image light forming device 4 includes a light modulation element such as a digital micromirror device (DMD) or a liquid crystal panel, electronic components that control the light modulation element, and the like.

The projection device 5 magnifies the image light output from the image light forming device 4 and projects the image light onto a display surface such as a screen.

The casing 6 accommodates the light source device 3, the image light forming device 4, the projection device 5, the blower fan 7, and the duct 8. The casing 6 includes a bottom plate 61 on which the light source device 3, the image light forming device 4, the projection device 5, the blower fan 7, and the duct 8 are mounted, and an upper cover 62 that covers the light source device 3, the image light forming device 4, the projection device 5, and the blower fan 7, and the duct 8 from above.

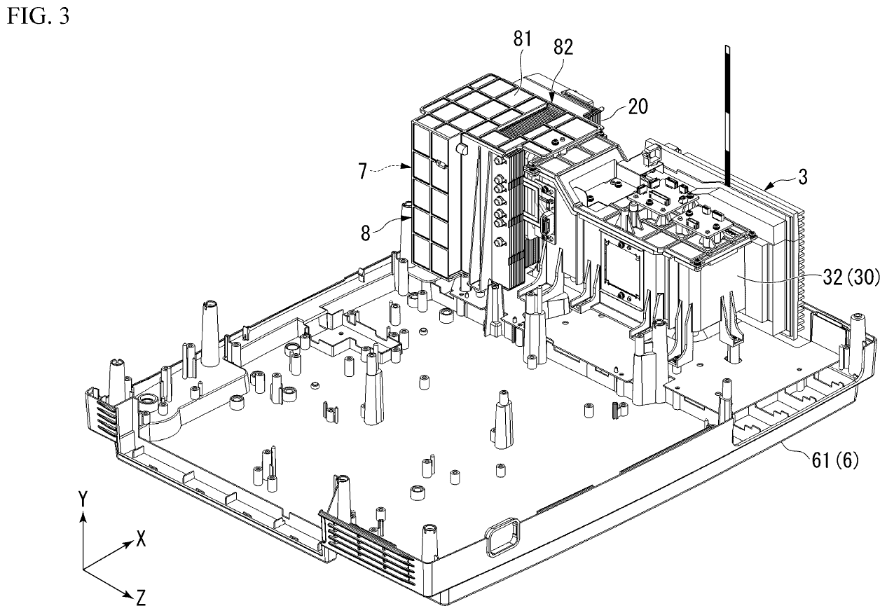

The light source device 3, the blower fan 7, and the duct 8 shown in FIGS. 3 to 7 configure a cooling structure for the light source device 3 that cools a light source 10 of the light source device 3, which will be described later.

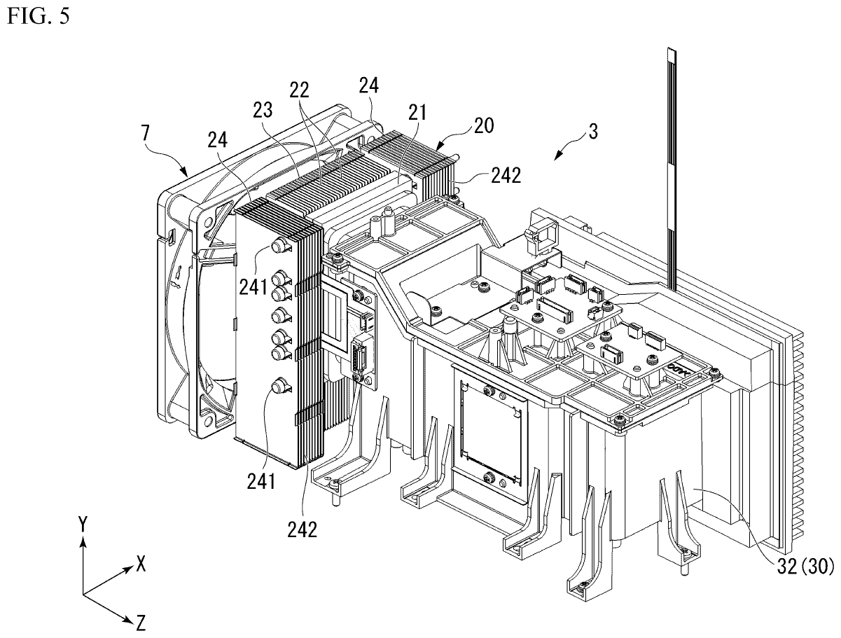

As shown in FIGS. 5 to 7, the light source device 3 includes a light source 10, a heat dissipator 20, and an optical system 30.

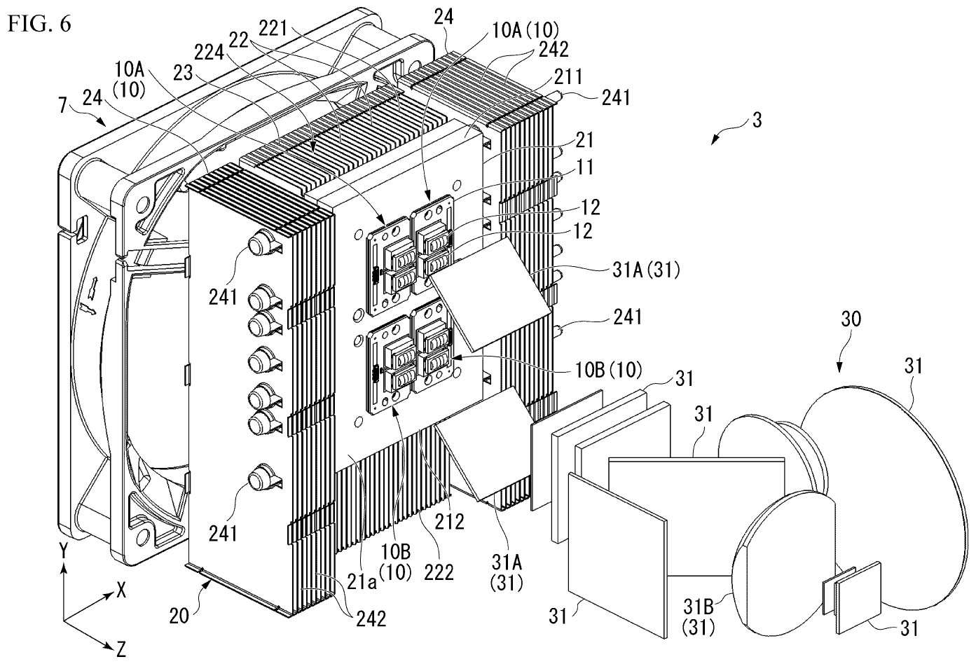

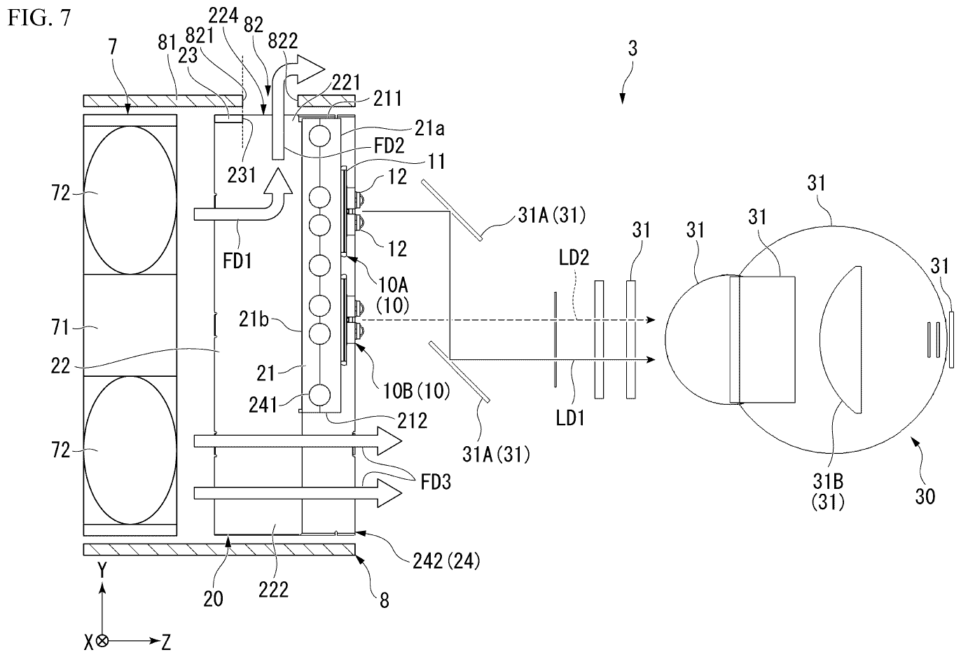

The light source 10 shown in FIGS. 6 and 7 emits light. The light source device 3 of the present embodiment has a plurality of (four in the illustrated example) light sources 10. Each light source 10 includes a board 11 and a light emitting element 12 mounted on the board 11. The light emitting element 12 may be, for example, a light emitting diode (LED), and is a laser diode in the present embodiment. The light emitting element 12 of the present embodiment emits laser light in a blue wavelength range. That is, the light source 10 of the present embodiment is a laser board. The number of light emitting elements 12 included in the light source 10 may be two as shown in the illustrated example, but is not limited to this.

The heat dissipator 20 is for cooling the light source 10 and includes a heat dissipation plate 21, a plurality of heat dissipation fins 22, and an extended heat dissipator 24.

The heat dissipation plate 21 is formed into a plate shape having a mounting surface 21a and a back surface 21b opposite to the mounting surface 21a. The mounting surface 21a and the back surface 21b are formed to be generally flat and are generally parallel to each other.

In FIGS. 3 to 7, a first direction along the mounting surface 21a and the back surface 21b is shown as an X-axis direction, and a second direction orthogonal to the first direction along the mounting surface 21a and the back surface 21b is shown as a Y-axis direction. An orthogonal direction orthogonal to the mounting surface 21a and the back surface 21b is shown as a Z-axis direction. The Z-axis direction corresponds to a plate thickness direction of the heat dissipation plate 21.

As shown in FIGS. 6 and 7, the light source 10 described above is mounted on the mounting surface 21a. Specifically, the board 11 of the light source 10 is mounted on the mounting surface 21a in an overlapping manner. Although the board 11 may be in direct contact with the mounting surface 21a, for example, thermally conductive grease may be interposed between the board 11 and the mounting surface 21a to improve heat transfer from the board 11 to the heat dissipator 20. The heat dissipation plate 21 is made of a highly conductive material such as copper.

In a state in which the light source 10 is mounted on the mounting surface 21a, light generated from the light emitting element 12 of the light source 10 is mainly directed in a direction away from the mounting surface 21a (in the illustrated example, the Z-axis positive direction). In FIG. 7, arrows LD1 and LD2 indicate a direction in which light emitted from the light source 10 travels.

In the present embodiment, the light source 10 mounted on the mounting surface 21a includes a first light source 10A and a second light source 10B. The first light source 10A is located on a first edge 211 (an end on the Y-axis positive direction side) side of the heat dissipation plate 21 in the second direction. The second light source 10B is located on a second edge 212 (an end on the Y-axis negative direction side) side of the heat dissipation plate 21 in the second direction. In FIG. 6, in each of the first and second light sources 10A and 10B, two light sources are arranged in the first direction, but the present invention is not limited to this.

The plurality of heat dissipation fins 22 are mainly provided on the back surface 21b of the heat dissipation plate 21. The plurality of heat dissipation fins 22 are each formed in a plate shape in which the first direction along the back surface 21b of the heat dissipation plate 21 is a thickness direction. Each heat dissipation fin 22 extends in the second direction along the back surface 21b of the heat dissipation plate 21, and extends from the back surface 21b in the orthogonal direction (Z-axis direction) orthogonal to the back surface 21b. The plurality of heat dissipation fins 22 are arranged at intervals in the first direction.

Each of first ends 221 of the plurality of heat dissipation fins 22 in the second direction (hereinafter also referred to as “a plurality of first ends 221”) does not protrude outside of the first edge 211 of the heat dissipation plate 21 in the second direction. Specifically, the plurality of first ends 221 and the first edge 211 of the heat dissipation plate 21 are disposed at the same position in the second direction. In the illustrated example, the plurality of first ends 221 and the first edge 211 of the heat dissipation plate 21 are the ends of the heat dissipation fins 22 and the heat dissipation plate 21 located on the Y-axis positive direction side.

On the other hand, respective second ends 222 of the plurality of heat dissipation fins 22 (hereinafter also referred to as “a plurality of second ends 222”) located on the opposite side to the first ends 221 of the plurality of heat dissipation fins 22 in the second direction protrude outside of the second edge 212 of the heat dissipation plate 21 in the second direction.

As shown in FIGS. 6 and 7, the plurality of heat dissipation fins 22 include a cover 23. The cover 23 is integrally provided at each first end 221 of the plurality of heat dissipation fins 22. The cover 23 covers a region corresponding to each distal end in the extension direction of the plurality of heat dissipation fins 22 (hereinafter referred to as “each distal end of the plurality of heat dissipation fins 22”) extending in the direction away from the back surface 21b of the heat dissipation plate 21 (Z-axis negative direction) in a gap between the heat dissipation fins 22 adjacent in the first direction.

The cover 23 does not cover a region corresponding to each basal end in the extending direction of the plurality of heat dissipation fins 22 (hereinafter referred to as “each basal end of the plurality of heat dissipation fins 22”) in the gap between adjacent heat dissipation fins 22. As a result, an opening 224 is formed at a position corresponding to each of the basal ends of the plurality of heat dissipation fins 22 in the first ends 221 of the plurality of heat dissipation fins 22 such that the gap between the adjacent heat dissipation fins 22 faces the outside of the plurality of heat dissipation fins 22.

The cover 23 of the present embodiment is formed on each heat dissipation fin 22 and functions as a connector (stack) that connects adjacent heat dissipation fins 22 when a plurality of heat dissipation fins 22 are stacked and assembled. For example, the cover 23 formed on a predetermined heat dissipation fin 22 is engaged with another heat dissipation fin 22 adjacent to the predetermined heat dissipation fin 22, and thus the predetermined heat dissipation fin 22 is connected to another heat dissipation fin 22 while securing a gap between the predetermined heat dissipation fin 22 and another heat dissipation fin 22.

As shown in FIGS. 5 and 6, the extended heat dissipator 24 protrudes from both ends of the heat dissipation plate 21 in the first direction. The extended heat dissipator 24 may extend from only one end of the heat dissipation plate 21 in the first direction, for example. The extended heat dissipator 24 is configured to dissipate heat by causing air to flow through the extended heat dissipator 24 in the orthogonal direction (Z-axis direction) orthogonal to the mounting surface 21a.

The extended heat dissipator 24 includes a heat pipe 241 and a plurality of heat dissipation fins 242 attached to the heat pipe 241. The heat pipe 241 extends from the end of the heat dissipation plate 21 in the first direction. The heat pipe 241 penetrates through the heat dissipation plate 21 in the first direction and extends from both ends of the heat dissipation plate 21 (see FIG. 7). A plurality of (seven in the illustrated example) heat pipes 241 are arranged in the second direction.

The plurality of heat dissipation fins 242 of the extended heat dissipator 24 are each formed in a plate shape in which the first direction is a thickness direction. The plurality of heat dissipation fins 242 are arranged at intervals in the first direction on both sides of the heat dissipation plate 21 in the first direction. The heat pipe 241 is attached to the plurality of heat dissipation fins 242 to penetrate through the heat dissipation fins 242 in the thickness direction.

In the extended heat dissipator 24 configured as described above, air can flow in the orthogonal direction (Z-axis direction) between the plurality of heat dissipation fins 242.

The heat dissipator 20 has the extended heat dissipator 24, and thus the light source 10 can be cooled with high efficiency.

As shown in FIGS. 5 to 7, the optical system 30 is disposed on the mounting surface 21a side of the heat dissipation plate 21 where the light source 10 is disposed. The optical system 30 processes the light (blue light) from the light source 10 as appropriate and emits white light to the image light forming device 4. The optical system 30 includes a plurality of optical system components 31 for processing light from the light source 10 as appropriate, and a case 32 that accommodates these optical system components 31.

The optical system components 31 include a reflection mirror 31A, a lens 31B, and the like. The reflection mirror 31A reflects light traveling in the orthogonal direction (Z-axis positive direction) from the first light source 10A that is located to be deviated in the second direction (Y-axis positive direction) from the second light source 10B in the second direction. Consequently, the light from the first light source 10A travels in the orthogonal direction (Z-axis positive direction) near the light from the second light source 10B. In FIG. 7, an arrow LD1 indicates a direction in which light emitted from the first light source 10A travels, and an arrow LD2 indicates a direction in which light emitted from the second light source 10B travels. The lens 31B collects the light from, for example, the first and second light sources 10A and 10B.

The case 32 of the optical system 30 shown in FIG. 5 has an opening (not shown) that allows the light emitted from the light source 10 to enter the inside of the case 32. The light source 10 can be covered by the case 32 because the edge of the opening of the case 32 comes into close contact with a region around the light source 10 on the mounting surface 21a. Consequently, dust on the outside of the case 32 can be curbed or prevented from reaching the light source 10.

As shown in FIGS. 5 to 7, the blower fan 7 is disposed to face the back surface 21b of the heat dissipation plate 21 via the plurality of heat dissipation fins 22, and mainly blows air toward the back surface 21b of the heat dissipation plate 21. The blower fan 7 is also disposed to face the extended heat dissipator 24. The blower fan 7 is located on the Z-axis negative direction side with respect to the plurality of heat dissipation fins 22 and the extended heat dissipator 24. The blower fan 7 blows air toward the plurality of heat dissipation fins 22 and the extended heat dissipator 24 in the Z-axis positive direction.

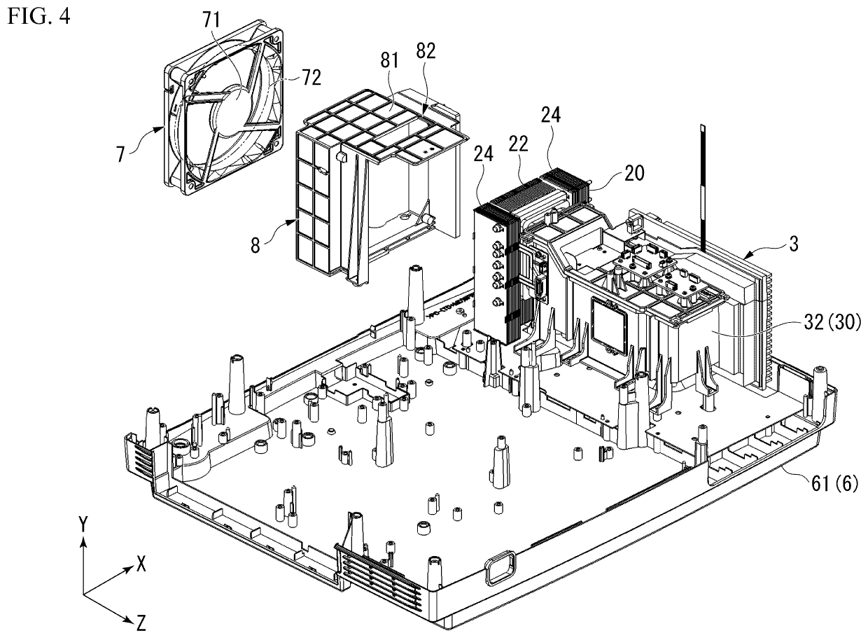

As shown in FIGS. 4 and 7, the blower fan 7 of the present embodiment is an axial fan having a shaft 71 and a blade 72 disposed around the shaft 71. An axis of the shaft 71 of the blower fan 7 is directed in the extension direction (Z-axis direction) of the heat dissipation fins 22 extending from the back surface 21b of the heat dissipation plate 21 toward the blower fan 7.

As shown in FIG. 7, the shaft 71 is located to correspond to the second light source 10B in the second direction. The blade 72 is located to correspond to the first light source 10A and each second end 222 of the plurality of heat dissipation fins 22 in the second direction. That is, the shaft 71 and the second light source 10B are arranged in the orthogonal direction (Z-axis direction), and the blade 72, the first light source 10A, and the plurality of second ends 222 are arranged in the orthogonal direction.

In the present embodiment, the dimensions of the blower fan 7 in the second direction are approximately the same as the dimensions of the heat dissipator 20 in the second direction. The dimensions of the blower fan 7 in the first direction are approximately the same as the dimensions of the heat dissipator 20 in the first direction.

As shown in FIGS. 3, 4, and 7, the duct 8 extends from the blower fan 7 toward the plurality of heat dissipation fins 22 and the extended heat dissipator 24 to define a flow path from the blower fan 7 to the plurality of heat dissipation fins 22 and the extended heat dissipator 24. The duct 8 of the present embodiment is formed into a tubular shape surrounding the blower fan 7 and the heat dissipator 20. The duct 8 mainly surrounds the entire blower fan 7 and a portion of the heat dissipator 20 on the blower fan 7 side. Note that a part of the duct 8 may be formed by, for example, a wall of the casing (for example, the bottom plate 61).

As shown in FIG. 7, a part 81 of the duct 8 (hereinafter referred to as a first part 81 of the duct 8) located on the first ends 221 side of the plurality of respective heat dissipation fins 22 is formed not to cover the openings 224 formed in the plurality of first ends 221.

Specifically, a ventilation opening 82 is formed in the first part 81 of the duct 8 such that the openings 224 face the outside of the plurality of heat dissipation fins 22. In the present embodiment, a shape of the ventilation opening 82 when viewed from the second direction corresponds to the shape of the opening 224 described above. That is, an edge 821 of the ventilation opening 82 on the blower fan 7 side in the orthogonal direction (Z-axis negative direction side) (hereinafter referred to as a first edge 821 of the ventilation opening 82) is disposed at a position corresponding to an edge 231 of the cover 23 in the orthogonal direction on the heat dissipation plate 21 side (hereinafter referred to as a first edge 231 of the cover 23) in the orthogonal direction. An edge 822 of the ventilation opening 82 on the heat dissipation plate 21 side in the orthogonal direction (Z-axis negative direction side) (hereinafter referred to as a second edge 822 of the ventilation opening 82) is disposed at a position corresponding to the back surface 21b of the heat dissipation plate 21 in the orthogonal direction.

In the cooling structure for the light source device 3 of the present embodiment and the projector 1 including the same, the cover 23 that covers the gap between the heat dissipation fins 22 adjacent in the first direction (X-axis direction) is provided at a position corresponding to each of the distal ends of the plurality of heat dissipation fins 22 in the extension direction (Z-axis negative direction) in the first ends 221 of the plurality of heat dissipation fins 22 in the second direction (Y-axis direction). Thus, a flow of air from the blower fan 7 toward the back surface 21b of the heat dissipation plate 21 can be prevented from escaping from the gap between the heat dissipation fins 22 to the outside at each distal end of the plurality of heat dissipation fins 22 in the plurality of first ends 221 in the second direction. Consequently, the air flowing out from the blower fan 7 can be efficiently made to reach the back surface 21b of the heat dissipation plate 21. An arrow FD1 in FIG. 7 indicates a flow direction of air reaching the back surface 21b of the heat dissipation plate 21 from the blower fan 7.

The opening 224 is formed in a position corresponding to each basal end side of the plurality of heat dissipation fins 22 (the side close to the back surface 21b of the heat dissipation plate 21) such that a gap between the heat dissipation fins 22 is not covered by the cover 23 and faces the outside. Thus, the air that has reached the back surface 21b of the heat dissipation plate 21 can flow outward through the opening 224 from the gap between the heat dissipation fins 22. Consequently, the heat of the light source 10 mounted on the heat dissipation plate 21 can be efficiently released. An arrow FD2 in FIG. 7 schematically indicates a direction in which air that has reached the back surface 21b of the heat dissipation plate 21 flows outward through the opening 224.

From the above description, even if there is a restriction on a space in which the light source device 3 is installed, the cooling efficiency of the light source 10 can be improved.

In the cooling structure for the light source device 3 of the present embodiment and the projector 1 including the same, the duct 8 that forms a flow path from the blower fan 7 to the plurality of heat dissipation fins 22 is provided. Therefore, even if the blower fan 7 and the heat dissipation fins 22 are disposed with a gap therebetween, air can be prevented from escaping to the outside through the gap between the blower fan 7 and the heat dissipation fins 22. Consequently, air flowing out from the blower fan 7 can be efficiently made to reach the plurality of heat dissipation fins 22.

In the cooling structure for the light source device 3 of the present embodiment and the projector 1 including the same, the part of the duct 8 that covers the cover 23 does not cover the opening 224. Consequently, it is possible to prevent the duct 8 from obstructing a flow of air that has reached the back surface 21b of the heat dissipation plate 21 from the blower fan 7, the air flowing outward from the gaps between the heat dissipation fins 22.

In the cooling structure for the light source device 3 of the present embodiment and the projector 1 including the same, the cover 23 is provided at each of the first ends 221 of the plurality of heat dissipation fins 22 in the second direction. Thus, on the plurality of first ends 221 side, the heat transferred from the light source 10 to the first edge 211 of the heat dissipation plate 21 can be dissipated by air flowing outward through the opening 224 from the blower fan 7 via the back surface 21b of the heat dissipation plate 21.

On the other hand, each of the second ends 222 of the plurality of heat dissipation fins 22 in the second direction protrudes from the second edge 212 of the heat dissipation plate 21 in the second direction (Y-axis negative direction). Thus, on the plurality of second ends 222 side, the heat transferred from the light source 10 to the second edge 212 of the heat dissipation plate 21 can be transferred to a large portion of the plurality of heat dissipation fins 22 (that is, the plurality of second ends 222) protruding outside of the second edge 212 of the heat dissipation plate 21 and then dissipated by air that flows from the blower fan 7. An arrow FD3 in FIG. 7 indicates a flow direction in which air from the blower fan 7 passes through the plurality of second ends 222.

From the above description, the heat of the light source 10 can be efficiently dissipated.

In the cooling structure for the light source device 3 of the present embodiment and the projector 1 including the same, the first light source 10A located on the first edge 211 side of the heat dissipation plate 21 in the second direction is located to correspond to the blade 72 of the blower fan 7 in the second direction. Thus, the heat of the first light source 10A can be dissipated by air that flows from the blade 72 of the blower fan 7 toward the portion on the first edge 211 side of the heat dissipation plate 21 that overlaps the first light source 10A and then flows outward from the opening 224 (see the arrows FD1 and FD2 in FIG. 7).

On the other hand, the second light source 10B located on the second edge 212 side of the heat dissipation plate 21 in the second direction is located to correspond to the shaft 71 of the blower fan 7 in the second direction. Therefore, the air flowing from the blower fan 7 is difficult to reach the portion on the second edge 212 side of the heat dissipation plate 21 that overlaps the second light source 10B. However, each of the second ends 222 of the plurality of heat dissipation fins 22 protruding from the second edge 212 of the heat dissipation plate 21 in the second direction is located to correspond to the blade 72 of the blower fan 7. Therefore, the heat of the second light source 10B transferred to the large portion (that is, the plurality of second ends 222) of the heat dissipation fins 22 protruding outside of the second edge 212 of the heat dissipation plate 21 can be dissipated by air flowing from the blower fan 7.

From the above description, even if the blower fan 7 is an axial fan, it is possible to prevent uneven dissipation of heat from the first and second light sources 10A and 10B.

Although the embodiments of the present invention have been described above, the present invention is not limited to the above embodiments, and can be modified as appropriate without departing from the spirit thereof.

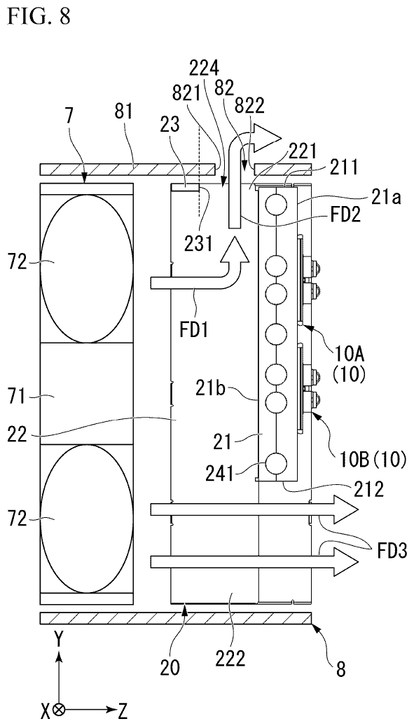

In the present invention, for example, as shown in FIG. 8, the first part 81 of the duct 8 may be formed to cover a part of the opening 224 formed in each of the first ends 221 of the plurality of heat dissipation fins 22.

In the configuration exemplified in FIG. 8, the first edge 821 of the ventilation opening 82 formed in the first part 81 of the duct 8 is located to be closer to the heat dissipation plate 21 than the first edge 231 of the cover 23 in the orthogonal direction. Thus, the first part 81 of the duct 8 covers the portion of the opening 224 on the blower fan 7 side.

In the configuration exemplified in FIG. 8, the first part 81 of the duct 8 covers a part of the opening 224. Consequently, a size of the opening 224 can be appropriately adjusted by using the duct 8 according to an amount of air blown by the blower fan 7 without changing the design of the plurality of heat dissipation fins 22 including the cover 23 and the opening 224. That is, a substantial size of the opening 224 can be adjusted such that the cooling efficiency of the light source 10 is improved.

In the configuration exemplified in FIG. 8, the first part 81 of the duct 8 covers the portion of the opening 224 on the blower fan 7 side. Thus, compared with a case where the first part 81 of the duct 8 covers the portion of the opening 224 on the heat dissipation plate 21 side, air that has reached the back surface 21b of the heat dissipation plate 21 from the blower fan 7 can be made to smoothly flow outward from the opening 224. Consequently, even if the first part 81 of the duct 8 covers a part of the opening 224, it is possible to curb or prevent the cooling efficiency of the light source 10 from decreasing.

In the present invention, the heat dissipator 20 does not need to include the extended heat dissipator 24, for example.

### REFERENCE SIGNS LIST

1 Projector
3 Light source device
7 Blower fan
8 Duct
10 Light source
10A First light source
10B Second light source
20 Heat dissipator
21 Heat dissipation plate
21a Mounting surface
21b Back surface
211 First edge
212 Second edge
22 Heat dissipation fin
221 First end
222 Second end
224 Opening
23 Cover
71 Shaft
72 Blade
81 First part of duct
82 Ventilation opening

What is claimed is:

1. A cooling structure for a light source device comprising:
a light source;
a heat dissipation plate having a mounting surface on which the light source is mounted;
a plurality of heat dissipation fins formed in a plate shape in which a first direction along a back surface of the heat dissipation plate opposite to the mounting surface is a thickness direction and arranged at intervals in the first direction; and
a blower fan disposed to face the back surface via the plurality of heat dissipation fins and blowing air toward the back surface, wherein
each of first ends of the plurality of heat dissipation fins in a second direction orthogonal to the first direction along the back surface does not protrude outside of a first edge of the heat dissipation plate in the second direction,
the plurality of heat dissipation fins are provided with a cover that is provided at the plurality of first ends and covers a region corresponding to each distal end in an extension direction of the plurality of heat dissipation fins extending from the back surface toward the blower fan in a gap between the heat dissipation fins adjacent in the first direction, and
a region corresponding to each basal end in the extension direction of the plurality of heat dissipation fins in the gap between the adjacent heat dissipation fins is covered with the cover, and thus an opening is formed at a position corresponding to each of the plurality of basal ends of the plurality of first ends such that the gap between adjacent heat dissipation fins faces the outside of the plurality of heat dissipation fins.

2. The cooling structure for a light source device according to claim 1, further comprising:
a duct extending from the blower fan toward the plurality of heat dissipation fins and defining a flow path from the blower fan to the plurality of heat dissipation fins, wherein
a part of the duct located on the plurality of first ends side is formed not to cover the opening.

3. The cooling structure for a light source device according to claim 2, wherein the duct has a ventilation opening that allows the opening to face the outside of the plurality of heat dissipation fins.

4. The cooling structure for a light source device according to claim 2, wherein the duct has a ventilation opening that allows the opening to face the outside of the plurality of heat dissipation fins.

5. The cooling structure for a light source device according to claim 2, wherein each second end of the plurality of heat dissipation fins in the second direction protrudes outside of a second edge of the heat dissipation plate in the second direction.

6. The cooling structure for a light source device according to claim 5, wherein the plurality of second ends are located on an opposite side to the plurality of first ends in the second direction.

7. The cooling structure for a light source device according to claim 5, wherein the light source includes a first light source located on the first edge side and a second light source located on the second edge side.

8. The cooling structure for a light source device according to claim 7, wherein
the blower fan is an axial fan having a shaft in which an axis is directed in the extension direction, and a blade disposed around the shaft, and
in the second direction, the shaft is located to correspond to the second light source, and the blade is located to correspond to the first light source and the plurality of second ends.

9. A projector comprising:
a case;
a light source;
a light source;
a heat dissipation plate formed in a plate shape and having a mounting surface on which the light source is mounted;
a plurality of heat dissipation fins formed in a plate shape in which a first direction along a back surface of the heat dissipation plate opposite to the mounting surface is a thickness direction and arranged at intervals in the first direction; and
a blower fan disposed to face the back surface via the plurality of heat dissipation fins and blowing air toward the back surface, wherein
each of first ends of the plurality of heat dissipation fins in a second direction orthogonal to the first direction along the back surface does not protrude outside of a first edge of the heat dissipation plate in the second direction,
the plurality of heat dissipation fins are provided with a cover that is provided at the plurality of first ends and covers a region corresponding to each distal end in an extension direction of the plurality of heat dissipation fins extending from the back surface toward the blower fan in a gap between the heat dissipation fins adjacent in the first direction, and
a region corresponding to each basal end in the extension direction of the plurality of heat dissipation fins in the gap between the adjacent heat dissipation fins is covered with the cover, and thus an opening is formed at a position corresponding to each of the plurality of basal ends of the plurality of first ends such that the gap between adjacent heat dissipation fins faces the outside of the plurality of heat dissipation fins.
